(19) United States
(12) Patent Application Publication
(10) Pub. No.: US 2018/0282493 A1
(43) Pub. Date: Oct. 4, 2018

(54) MASTERBATCH COMPOSITION AND RUBBER COMPOSITION INCLUDING GLASS BUBBLES AND A TOUGHENING AGENT AND RELATED METHODS

(71) Applicant: 3M INNOVATIVE PROPERTIES COMPANY, St. Paul, MN (US)

(72) Inventors: Dae-Soon Park, Gyeonggi-do (KR); Sung Wook Lim, Busan (KR); Stephen E. Amos, Minneapolis, MN (US); Per M. Nelson, Woodbury, MN (US)

(21) Appl. No.: 15/766,254

(22) PCT Filed: Oct. 7, 2016
(86) PCT No.: PCT/US2016/056066

§ 371 Date: Apr. 5, 2018

Related U.S. Application Data
(60) Provisional application No. 62/239,304, filed on Oct. 9, 2015.

(51) Int. Cl. C08J 3/22; C08L 9/00; B29D 35/12; A43B 13/04

(52) U.S. Cl. CPC C08J 3/226; C08L 9/00; B29D 35/122; A43B 13/04; C08J 2309/00; B29K 2009/00; C08L 2205/025; C08L 2310/00; C08J 2427/18; C08J 2407/00; C08J 2409/00

(57) ABSTRACT

A masterbatch composition including glass bubbles and a toughening agent in a blend of syndiotactic 1,2-poly-butadiene and cis-1,4-polybutadiene is disclosed. The glass bubbles are present in an amount of at least 25 percent by weight, based on the total weight of the masterbatch composition. A method of making a rubber composition from the masterbatch composition is disclosed as well as a rubber composition and vulcanized rubber made from the masterbatch composition. A rubber composition that includes syndiotactic 1,2-polybutadiene, cis-1,4-polybutadiene, a toughening agent that includes at least one of a fluoroplastic or an organic or ceramic fiber, and glass bubbles in an amount up to 25 percent by weight, based on the total weight of the rubber composition, is also disclosed.

### CROSS-REFERENCE TO RELATED APPLICATION

This application claims priority to U.S. Provisional Application No. 62/239,304, filed Oct. 9, 2015, the disclosure of which is incorporated by reference in its entirety herein.

### BACKGROUND

Glass bubbles having an average diameter of less than about 500 micrometers, also commonly known as “glass microbubbles”, “hollow glass microspheres”, “hollow glass beads”, or “glass balloons” are widely used in industry, for example, as additives to polymeric compositions. In many industries, glass bubbles are useful, for example, for lowering weight and improving processing, dimensional stability, and flow properties of a polymeric composition. Generally, it is desirable that the glass bubbles be strong enough to avoid being crushed or broken during processing of the particular polymeric compound. Glass bubbles have been incorporated into rubber compositions. For example, glass bubbles have been incorporated into rubber compositions for shoe outsoles to lower the weight of the rubber composition. See, e.g., Korean Patent Nos. 100894516, published Apr. 22, 2009; 100868885, published Nov. 17, 2009; and 101217692, published Jan. 2, 2013, and Int. Pat. Appl. Pub. No. WO 2014/00445, published Jan. 3, 2014.

### SUMMARY

While including glass bubbles in polymeric compositions can provide many benefits, the process of adding glass bubbles into a polymer in a manufacturing process can pose some challenges. Handling glass bubbles may be similar to handling light powders. The glass bubbles may not be easily contained and difficult to use in a clean environment. It can also be difficult to add an accurate amount of glass bubbles to the polymer. The present disclosure provides a masterbatch composition useful, for example, for incorporating glass bubbles into a final, end-use rubber composition. Delivering the glass bubbles in a masterbatch composition can eliminate at least some of the handling difficulties encountered during manufacturing.

Making a masterbatch composition also provides challenges, however. It is desirable for a masterbatch composition to have a relatively high loading of glass bubbles with minimal breakage to achieve the greatest benefits in the final, end-use composition. It is also desirable for the masterbatch composition to be readily incorporated into a variety of host resins to provide flexibility in formulating the final, end-use composition.

Int. Pat. Appl. Pub. No. WO 2014/00445, published Jan. 3, 2014, discloses a masterbatch composition that includes syndiotactic 1,2-polybutadiene and cis-1,4-polybutadiene and a relatively high level of glass bubbles. The masterbatch composition is compatible with a variety of rubber resins that include natural rubber and/or polybutadienes for letting down the masterbatch composition to provide compositions with final properties useful, for example, for outer soles of shoes. Korean Pat. No. 101217692, published Jan. 2, 2013, reports syndiotactic 1,2-polybutadiene as useful for compensating for decreases in mechanical properties and abrasion resistance observed when hollow filler was added to a rubber composition. Despite this teaching, we have found that glass bubbles decrease abrasion resistance of certain rubber formulations, even in the presence of syndiotactic 1,2-polybutadiene. We have now found that certain toughening agents can be added to masterbatches and rubber compositions to provide lightweight, abrasion resistant products.

In one aspect, the present disclosure provides a masterbatch composition that includes glass bubbles and a toughening agent in a blend of syndiotactic 1,2-polybutadiene and cis-1,4-polybutadiene. In some embodiments, the toughening agent is a fluoroplastic, a silicone rubber, an organic or ceramic fiber, or a combination thereof.

In another aspect, the present disclosure provides a method that includes combining a masterbatch disclosed herein with at least one of a polyisoprene or a polybutadiene to provide a rubber composition.

In another aspect, the present disclosure provides a rubber composition that includes syndiotactic 1,2-polybutadiene, cis 1,4-polybutadiene, glass bubbles, a toughening agent, and optionally polyisoprene and silica. The toughening agent is at least one of a fluoroplastic or a fiber. The glass bubbles can be present in a range from 5 to 20 percent by weight, based on the total weight of the rubber composition. The ratio of syndiotactic 1,2-polybutadiene to cis-1,4-polybutadiene is typically in a range from 50:50 to 10:90. In another aspect, the present disclosure provides a vulcanized rubber prepared from this rubber composition. In another aspect, the present disclosure provides a shoe sole made from this rubber composition.

For the rubber composition disclosed herein, the presence of glass bubbles can provide a productivity improvement by enhancing flow properties and reducing specific heat so that cooling times or curing times may be reduced. Furthermore, the final, vulcanized rubber compositions including glass bubbles are typically lighter weight, less flammable, more dimensionally stable, and have better thermal insulation properties (which may be useful, e.g., in boots for firefighters) than products that do not contain glass bubbles.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. The term “fluoroplastic” includes crystalline, fluorinated polymers of any molecular weight and includes fibrillating fluoroplastics and non-fibrillating fluoroplastics. A subset of fluoroplastics are fluorothermoplastics, which are melt-processable. The term “fluoroplastic” is understood to exclude fluoroelastomers, which are amorphous materials. All numerical ranges are inclusive of their endpoints and non-integral values between the endpoints unless otherwise stated (e.g., 1 to 5 includes 1, 1.5, 2, 2.75, 3, 3.80, 4, 5, etc.).

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### DETAILED DESCRIPTION

The masterbatch composition and rubber composition according to the present disclosure include a toughening agent. A toughening agent for a rubber is a material that provides an improvement in abrasion, wear, and tear properties to the rubber. Various toughening agents may provide such an improvement through one or more mechanisms. A first type of toughening agent includes a fibrous or fibrillating material that may provide a net-like structure in the matrix to prevent wear or crack propagation through the bulk resin. A second type of toughening agent includes a material that is harder than the bulk composition but has similar elastic properties to provide a more durable bulk material. A third type of toughening agent, which is primarily focused on abrasion and wear, includes a material that has a lower surface energy than the bulk material to reduce friction at the interface of the bulk material and an abrading surface. While a toughening agent useful for practicing the present disclosure may fall into one or more of these categories, useful toughening agents are not limited to these mechanisms.

In some embodiments, the toughening agent in the masterbatch composition and/or rubber composition according to the present disclosure is a fibrous or fibrillating material. Fibers useful as toughening agents include organic fibers (e.g., nylon fibers, fluoroplastic fibers, polyethylene terephthalate fibers, cellulosic fibers, lignocelluosic fibers, and other polymeric fibers) and inorganic fibers (e.g., ceramic fibers, mineral fibers, and glass fibers). In some embodiments, the toughening agent is a fibrillating fluoroplastic. A fibrillating fluoroplastic may be added to the masterbatch composition or rubber composition in the form of a fine powder that fibrillates under the shear stress of compounding the composition. Fibrillating fluoroplastics generally have high molecular weights (e.g., greater than 10⁶ grams per mole) and high degrees of crystallinity. However, grades of fluoroplastics having relatively lower molecular weight or crystallinity may fibrillate if a high-enough shear force is applied. In some embodiments, the toughening agent is fibrillating polytetrafluoroethylene (PTFE). Other fluoroplastics that are also useful as fibrillating toughening agents include copolymers of tetrafluoroethylene (TFE) and at least one of hexafluoropropylene (HFP), a perfluorovinyl ether (e.g., perfluoromethyl vinyl ether, perfluoroethyl vinyl ether, perfluoropropyl vinyl ether, and perfluoroalkoxyalkyl vinyl ethers described in U.S. Pat. No. 6,255,536 (Worm et al.) and U.S. Pat. No. 6,294,627 (Worm et al.)), vinylidene fluoride, chlorotrifluoroethylene, vinyl fluoride, ethylene, or propylene. Still other fluoroplastics that are also useful as fibrillating toughening agents include polyvinylidene fluoride, polychlorotrifluoroethylene, ethylene-chlorotrifluoroethylene copolymer, and polyvinylfluoride. Compositions of copolymers can be selected to maintain sufficient crystallinity that the fluoroplastic is fibrillating at a desired shear rate. Generally, small amounts (e.g., up to one mole percent) of any comonomers are used. When provided as fine powders, the fibrillating fluoroplastics can have average particle sizes in a range from 0.001 micrometer to 1 micrometer. In some embodiments, the powders can have a particle structure including secondary particles having an average particle size in a range from 200 to 800 micrometers made up of primary particles less than 500 nanometers in size. Examples of useful fibrillating particles include those commercially available, for example, from 3M Company, St. Paul, Minn., under the trade designation “3M DYNEON TFM” modified PTFE fine powder (e.g., grades “TFM 2001Z” and “TFM 2070Z”). In some embodiments, the toughening agent is a fibrillating ultra-high molecular weight polyethylene.

Fibers useful as toughening agents, including any of the embodiments of fibers described above, can have a variety of cross-section shapes and can have length-to-width aspect ratios of at least 10:1, 25:1, 50:1, 75:1, 100:1, 150:1, 200:1, 250:1, 500:1, 1000:1, or more; or in a range from 2:1 to 1000:1. Fibers useful as toughening agents include those having a length up to 60 mm, in some embodiments, in a range from 0.25 mm to 60 mm, 0.5 mm to 40 mm, 1 mm to 30 mm, or 2 mm to 20 mm. In some embodiments, the fibers disclosed herein have a maximum cross-sectional dimension up to 100 (in some embodiments, up to 90, 80, 70, 60, 50, 40, or 30) micrometers. For example, the fiber may have a circular cross-section with an average diameter in a range from 1 micrometer to 100 micrometers, 1 micrometer to 60 micrometers, or 10 micrometers to 50 micrometers. In another example, the fiber may have a rectangular cross-section with an average length (i.e., longer cross-sectional dimension) in a range from 1 micrometer to 100 micrometers, 1 micrometer to 60 micrometers, or 10 micrometers to 50 micrometers.

In some embodiments, the toughening agent in the masterbatch composition and/or rubber composition according to the present disclosure is a silicone elastomer, poly(butadiene-co-nitrile), hydrogenated nitrile-butadiene copolymer, fluorinated elastomer, fluorochlorinated elastomer, fluorobrominated elastomer, or a combination thereof. These toughening agents may be useful in rubber compositions including at least one of polyisoprene or a polybutadiene rubber and may function in these cases as the second type of toughening agent described above. As used herein, the term “polyisoprene” includes natural rubber and synthetic polyisoprene. Also, as used herein, unless otherwise specified, the term “polybutadiene” refers to any isomer of polybutadiene.

In some embodiments, the toughening agent in the masterbatch composition and/or rubber composition according to the present disclosure is a fluoroplastic, an ethylene-propylene copolymer, or an ethylene-propylene-diene terpolymer. These toughening agents may be useful in rubber compositions including polyisoprene or another polar rubber and may function in these cases as the third type of toughening agent described above. In these embodiments, the fluoroplastic is not necessarily a fibrillating fluoroplastic. It may include any of the monomers described above for fibrillating fluoroplastics but may have a lower molecular weight or different ratios of monomers such that the fluoroplastic is non-fibrillating under compounding conditions.

In some embodiments, the fluoroplastic useful as a toughening agent is granular or in the form of a micropowder. Fluoroplastic micropowders that may be useful as toughening agents include PTFE micropowders commercially available, for example, from 3M Company under the trade designations “3M DYNEON TF 9201Z”, “3M DYNEON TF 9205”, and “3M DYNEON TF 9207Z”, from Solvay Specialty Polymers under the trade designations “ALGOFLON” and “POLYMIST”, and from Guarniflon, Maflon Division, under the trade designation “LINEPLUS”. Such micropowders are typically low molecular weight PTFE prepared by emulsion polymerization. When provided as micropowders, the fluoroplastics can have average agglomerate particle sizes in a range from 1 micrometer to 20, 15, or 10 micrometers, and primary particle sizes of less than 500 nanometers. In some embodiments, the toughening agents is a granular PTFE. Granular PTFE is typically a high-molecular-weight PTFE prepared by suspension polymerization. The granular PTFE can include an additive to help facilitate uniform mixing of the PTFE into the rubber composition. Suitable additives can include glass fibers, carbon fibers, bronze powder, stainless steel powder, and molybdenum disulfide.

In some embodiments, the fluoroplastic useful as a toughening agent is a fluorinated thermoplastic. Examples of fluorinated thermoplastic polymers useful as toughening agents include fluoroplastics derived solely from VDF and HFP. These fluoroplastics typically have interpolymerized units derived from 99 to 67 weight percent of VDF and from 1 to 33 weight percent HFP, more in some embodiments, from 90 to 67 weight percent VDF and from 10 to 33 weight percent HFP. Another example of a useful fluoroplastic is a fluoroplastic having interpolymerized units derived solely from (i) TFE, (ii) more than 5 weight percent of one or more ethylenically unsaturated copolymerizable fluorinated monomers other than TFE. In some embodiments, these fluoroplastics are derived from copolymerizing 30 to 70 wt % TFE, 10 to 30 wt %, HFP, and 5 to 50 wt % of a third ethylenically unsaturated fluorinated comonomer other than TFE and HFP. For example, such a fluoropolymer may be derived from copolymerization of a monomer charge of TFE (e.g., in an amount of 45 to 65 weight %), HFP (e.g., in an amount of 10 to 30 weight %), and VDF (e.g., in an amount of 15 to 35 weight %). Another example of a useful fluoroplastic is a fluoroplastic derived from copolymerization of a monomer charge of TFE (e.g., from 45 to 70 weight %), HFP (e.g., from 10 to 20 weight %), and an alpha olefin hydrocarbon ethylenically unsaturated comonomer having from 1 to 3 carbon atoms, such as ethylene or propylene (e.g., from 10 to 20 weight %). Another example of a useful fluoroplastic is a fluoroplastic derived from TFE and an alpha olefin hydrocarbon ethylenically unsaturated comonomer. An example of a polymer of this subclass is a copolymer of TFE and propylene. Such copolymers are typcially derived by copolymerizing from 50 to 95 wt. %, in some embodiments, from 85 to 90 wt. %, of TFE with from 50 to 15 wt. %, in some embodiments, from 15 to 10 wt. %, of the comonomer.

A combination of any of the toughening agents described above may be useful. In some embodiments, a fluoroplastic, a silicone rubber, an organic or ceramic fiber, or a combination thereof. In some embodiments, the toughening agent is a fluoroplastic particle, a fluoroplastic fiber, or a combination thereof, including any of the embodiments of fluoroplastic particles and fibers described above. In some embodiments, the toughening agent is a fibrillating PTFE, which may be modified with one or more comonomers as described above.

In some embodiments of the rubber composition according to the present disclosure, the toughening agent is present in an amount of at least one percent by weight and up to ten percent (in some embodiments, 1 to 7.5 or 2 to 5 percent) by weight, based on the total weight of the rubber composition. In some cases, while a toughening agent can improve abrasion and tear resistance, it may also provide an increase in density or hardness or a decrease in tensile strength. Therefore, it may be useful to adjust the toughening agent level to the minimum level needed to achieve the desired effect. In some embodiments, the toughening agent can be present in an amount of 1 to 7.5 percent by weight, 2 to 5 percent by weight, or 1 to 3 percent by weight, based on the total weight of the rubber composition.

The toughening agent(s) may be added to the masterbatch composition, which can then be let-down into a rubber composition as described below, or the toughening agent may be added directly to the rubber composition. In some embodiments, it is useful for the toughening agent to be added to the masterbatch composition. For example, when the toughening agent is a fiber or particle (e.g., fluoroplastic or fibrillating particle), including the toughening agent in the masterbatch may provide handling advantages. In some embodiments of the masterbatch composition according to the present disclosure, the toughening agent is present in an amount of at least five percent by weight and up to 30 percent (in some embodiments, 5 to 25 or 10 to 20 percent) by weight, based on the total weight of the rubber composition.

The masterbatch composition according to the present disclosure includes a blend of syndiotactic 1,2-polybutadiene and cis-1,4-polybutadiene. In some embodiments, the blend consists of syndiotactic 1,2-polybutadiene and cis-1,4-polybutadiene (that is, the masterbatch composition does not include other polymers (e.g., rubber resins) other than syndiotactic 1,2-polybutadiene and cis-1,4-polybutadiene). A blend of syndiotactic 1,2-polybutadiene and cis-1,4-polybutadiene can readily be combined with glass bubbles, processed into a variety of masterbatch forms (e.g., sheet, pellet, or granular), and combined with other polymers (e.g., rubber resins) to make a final end-use composition. In some embodiments, the weight ratio of syndiotactic 1,2-polybutadiene to cis-1,4-polybutadiene in the blend is in a range from 30:70 to 80:20 or from 30:70 to 70:30. Examples of useful weight ratios of syndiotactic 1,2-polybutadiene to cis-1,4-polybutadiene include 40:60 and 70:30. If the masterbatch composition contains only cis-1,4-polybutadiene (without any syndiotactic 1,2-polybutadiene), the masterbatch composition may be too sticky to be provided in certain forms. For example, the masterbatch composition may be difficult to load into a granulator to prepare a masterbatch in pellet or granular form. Also, as reported in Int. Pat. Appl. Pub. No. WO 2014/00445, published Jan. 3, 2014, a masterbatch composition (Comparative Masterbatch Composition A) having only cis-1,4-polybutadiene (without any syndiotactic 1,2-polybutadiene) had a higher amount of glass bubble breakage during mixing than a masterbatch that also included syndiotactic 1,2-polybutadiene, as evidenced by the measured density of the masterbatch being 25% higher than the theoretical density.

Stereospecific polybutadienes including syndiotactic 1,2-polybutadiene and cis-1,4-polybutadiene can be obtained from a variety of commercial sources. For example, cis-1,4-polybutadiene is available from LG Chem, Ltd. (Seoul, South Korea) and Korea Kumho Petrochemical Co., (Seoul, South Korea) under the trade designations “BR-1208” and “KOSYN KBR-01L”, respectively. Syndiotactic 1,2-polybutadiene is available, for example, from JSR Corporation (Tokyo, Japan) under the trade designation “JSR RB-830”. Blends of syndiotactic 1,2-polybutadiene and cis-1,4-polybutadiene are also available, for example, from UBE America (New York City, N.Y.) under the trade designation “UBEPOL VCR-617”.

In some embodiments, the blend including syndiotactic 1,2-polybutadiene and cis-1,4-polybutadiene further includes another polybutadiene isomer, for example, up to 5 percent by weight, based on the total weight of the polymer blend in the masterbatch composition. Small amounts of polyisoprene (e.g., up to 5 percent by weight, based on the total weight of the polymer blend in the masterbatch composition) may also be present. However, in some embodiments, the masterbatch is substantially free of natural rubber. “Substantially free” of natural rubber means that the masterbatch contains up to 1 percent by weight natural rubber, based on the total weight of the polymer blend in the masterbatch composition. “Substantially free” of natural rubber can also mean free of natural rubber. Natural rubber is a tougher resin than some synthetic rubber resins, and high shear forces can result when natural rubber is used in the masterbatch composition. As a result, as shown for Comparative Master Batch B in Int. Pat. Appl. Pub. No. WO 2014/00445, published Jan. 3, 2014, a masterbatch composition having 5 percent by weight natural rubber had a higher amount of glass bubble breakage during mixing, as evidenced by the measured density of the masterbatch being significantly higher than the theoretical density. In masterbatch compositions that include only cis 1,4-polybutadiene and 1,2-syndiotactic polybutadiene, the measured density of the masterbatch composition was much closer to theoretical. For the same reason, in some embodiments, the masterbatch may be substantially free of the toughening agents of the second type described above, which are harder than cis 1,4-polybutadiene and 1,2-syndiotactic polybutadiene (e.g., silicone elastomer, poly(butadiene-co-nitrile), hydrogenated nitrile-butadiene copolymer, fluorinated elastomer, fluorochlorinated elastomer, fluorobrominated elastomer, or a combination thereof).

Glass bubbles useful for practicing the present disclosure can be made by techniques known in the art (see, e.g., U. S. Pat. No. 2,978,340 (Veatch et al.); U.S. Pat. No. 3,030,215 (Veatch et al.); U.S. Pat. No. 3,129,086 (Veatch et al.); and U.S. Pat. No. 3,230,064 (Veatch et al.); U.S. Pat. No. 3,365,315 (Beck et al.); U.S. Pat. No. 4,391,646 (Howell); U.S. Pat. No.4,767,726 (Marshall), and U.S. Pat. No. 9,006,302 (Amos et al.); and U. S. Pat. App. Pub. No. 2006/0122049 (Marshall et. al). Techniques for preparing glass bubbles typically include heating milled frit, commonly referred to as “feed”, which contains a blowing agent (e.g., sulfur or a compound of oxygen and sulfur).

Frit can be made by heating mineral components of glass at high temperatures until molten glass is formed. Any oven that is capable of achieving a temperature hot enough to melt glass may be useful. For example, solar ovens, such as those useful for cooking food, are capable of achieving a temperature of 900° F. (480° C.). The solar oven can incorporate various solar films, solar concentrators, and insulators to maintain the high temperature required to melt the glass and form the frit.

Although the frit and/or the feed may have any composition that is capable of forming a glass, typically, on a total weight basis, the frit comprises from 50 to 90 percent of SiO₂, from 2 to 20 percent of alkali metal oxide, from 1 to 30 percent of B₂O₃, from 0.005-0.5 percent of sulfur (for example, as elemental sulfur, sulfate or sulfite), from 0 to 25 percent divalent metal oxides (for example, CaO, MgO, BaO, SrO, ZnO, or PbO), from 0 to 10 percent of tetravalent metal oxides other than SiO₂ (for example, TiO₂, MnO₂, or ZrO₂), from 0 to 20 percent of trivalent metal oxides (for example, Al₂O₃, Fe₂O₃, or Sb₂O₃), from 0 to 10 percent of oxides of pentavalent atoms (for example, P₂O₅ or V₂O₅), and from 0 to 5 percent fluorine (as fluoride) which may act as a fluxing agent to facilitate melting of the glass composition. Additional ingredients are useful in frit compositions and can be included in the frit, for example, to contribute particular properties or characteristics (for example, hardness or color) to the resultant glass bubbles.

In some embodiments, the glass bubbles useful for practicing the present disclosure have a glass composition comprising more alkaline earth metal oxide than alkali metal oxide. In some of these embodiments, the weight ratio of alkaline earth metal oxide to alkali metal oxide is in a range from 1.2:1 to 3:1. In some embodiments, the glass bubbles have a glass composition comprising B₂O₃ in a range from 2 percent to 6 percent based on the total weight of the glass bubbles. In some embodiments, the glass bubbles have a glass composition comprising up to 5 percent by weight Al₂O₃, based on the total weight of the glass bubbles. In some embodiments, the glass composition is essentially free of Al₂O₃. “Essentially free of Al₂O₃” may mean up to 5, 4, 3, 2, 1, 0.75, 0.5, 0.25, or 0.1 percent by weight Al₂O₃. Glass compositions that are “essentially free of Al₂O₃” also include glass compositions having no Al₂O₃. Glass bubbles useful for practicing the present disclosure may have, in some embodiments, a chemical composition wherein at least 90%, 94%, or even at least 97% of the glass comprises at least 67% SiO₂, (e.g., a range of 70% to 80% SiO₂), a range of 8% to 15% of an alkaline earth metal oxide (e.g., CaO), a range of 3% to 8% of an alkali metal oxide (e.g., Na₂O), a range of 2% to 6% B₂O₃, and a range of 0.125% to 1.5% SO₃. In some embodiments, the glass comprises in a range from 30% to 40% Si, 3% to 8% Na, 5% to 11% Ca, 0.5% to 2% B, and 40% to 55% O, based on the total of the glass composition.

The “average true density” of glass bubbles is the quotient obtained by dividing the mass of a sample of glass bubbles by the true volume of that mass of glass bubbles as measured by a gas pycnometer. The “true volume” is the aggregate total volume of the glass bubbles, not the bulk volume. The average true density of the glass bubbles useful for practicing the present disclosure is generally at least 0.30 grams per cubic centimeter (g/cc), 0.35 g/cc, or 0.38 g/cc. In some embodiments, the glass bubbles useful for practicing the present disclosure have an average true density of up to about 0.6 g/cc. “About 0.6 g/cc” means 0.6 g/cc ±five percent. In some of these embodiments, the average true density of the glass bubbles is up to 0.55 g/cc or 0.50 g/cc. For example, the average true density of the glass bubbles disclosed herein may be in a range from 0.30 g/cc to 0.6 g/cc, 0.30 g/cc to 0.55 g/cc, 0.35 g/cc to 0.60 g/cc, or 0.35 g/cc to 0.55 g/cc. For the purposes of this disclosure, average true density is measured using a pycnometer according to ASTM D2840-69, “Average True Particle Density of Hollow Microspheres”. The pycnometer may be obtained, for example, under the trade designation “ACCUPYC 1330 PYCNOMETER” from Micromeritics, Norcross, Ga., or under the trade designations “PENTAPYCNOMETER” or “ULTRAPYCNOMETER 1000” from Formanex, Inc., San Diego, Calif. Average true density can typically be measured with an accuracy of 0.001 g/cc. Each of the density values provided above can be±five percent.

Glass bubbles useful for practicing the present disclosure can be selected to have a size that is smaller than the gap of a two-roll mill useful for blending the masterbatch disclosed herein with other materials. The size of the glass bubbles may be selected so that the median size is smaller than one-half of the gap of the two-roll mill. The median size is also called the D50 size, where 50 percent by volume of the glass bubbles in the distribution are smaller than the indicated size. As used herein, the term size is considered to be equivalent with the diameter and height of the glass bubbles. For the purposes of the present disclosure, the median size by volume is determined by laser light diffraction by dispersing the glass bubbles in deaerated, deionized water. Laser light diffraction particle size analyzers are available, for example, under the trade designation “SATURN DIGISIZER” from Micromeritics. The size distribution of the glass bubbles useful for practicing the present disclosure may be Gaussian, normal, or non-normal. Non-normal distributions may be unimodal or multi-modal (e.g., bimodal).

The glass bubbles useful in the masterbatch and rubber compositions disclosed herein typically need to be strong enough to survive a milling process (e.g., Banbury or two-roll milling) or other conventional mixing process for rubbers (e.g., internal mixing). A useful hydrostatic pressure at which ten percent by volume of the glass bubbles collapses is at least about 20 (in some embodiments, at least about 38, 50, or 55) Megapascals (MPa). “About 20 MPa” means 20 MPa±five percent. In some embodiments, a hydrostatic pressure at which ten percent by volume of the glass bubbles collapses can be at least 100, 110, or 120 MPa. In some embodiments, a hydrostatic pressure at which ten percent, or twenty percent, by volume of the glass bubbles collapses is up to 250 (in some embodiments, up to 210, 190, or 170) MPa. The hydrostatic pressure at which ten percent by volume of glass bubbles collapses may be in a range from 20 MPa to 250 MPa, 38 MPa to 210 MPa, or 50 MPa to 210 MPa. For the purposes of the present disclosure, the collapse strength of the glass bubbles is measured on a dispersion of the glass bubbles in glycerol using ASTM D3102-72 “Hydrostatic Collapse Strength of Hollow Glass Microspheres”; with the exception that the sample size (in grams) is equal to 10 times the density of the glass bubbles. Collapse strength can typically be measured with an accuracy of±about five percent. Accordingly, each of the collapse strength values provided above can be±five percent.

Glass bubbles useful for practicing the present disclosure can be obtained commercially and include those marketed by 3M Company, St. Paul, Minn., under the trade designation “3M GLASS BUBBLES” (e.g., grades S60, S60HS, iM30K, iM16K, S38HS, S38XHS, K42HS, K46, and H50/10000). In some embodiments, glass bubbles useful for practicing the present disclosure may be selected to have crush strengths of at least about 28 MPa, 34 MPa, 41 MPa, 48 MPa, 55 MPa, 70 MPa, or 100 MPa for 90% survival.

In some embodiments, the glass bubbles are present in the masterbatch composition disclosed herein at a level of at least 30 percent by weight, based on the total weight of the masterbatch composition. In some embodiments, the glass bubbles are present in the masterbatch composition at at least 32, 33, or 35 percent by weight based on the total weight of the masterbatch composition. In some embodiments, the glass bubbles are present in the masterbatch composition at a level of up to 60, 55, or 50 percent by weight, based on the total weight of the masterbatch composition. For example, the glass bubbles may be present in the masterbatch composition in a range from 30 to 60, 33 to 55, or 35 to 50 percent by weight, based on the total weight of the masterbatch composition.

In some embodiments of the masterbatch and/or rubber composition according to the present disclosure, the glass bubbles may be treated with a coupling agent to enhance the interaction between the glass bubbles and the rubber in the final rubber composition. In other embodiments, a coupling agent can be added directly to the masterbatch composition. Examples of useful coupling agents include zirconates, silanes, or titanates. Typical titanate and zirconate coupling agents are known to those skilled in the art and a detailed overview of the uses and selection criteria for these materials can be found in Monte, S. J., Kenrich Petrochemicals, Inc., “Ken-React® Reference Manual—Titanate, Zirconate and Aluminate Coupling Agents”, Third Revised Edition, March, 1995. If used, coupling agents are commonly included in an amount of about 1% to 3% by weight, based on the total weight of the glass bubbles in the composition.

Suitable silanes are coupled to glass surfaces through condensation reactions to form siloxane linkages with the siliceous glass. This treatment renders the glass bubbles more wet-able or promotes the adhesion of materials to the glass bubble surface. This provides a mechanism to bring about covalent, ionic or dipole bonding between glass bubbles and organic matrices. Silane coupling agents are chosen based on the particular functionality desired. Another approach to achieving intimate glass bubble-polymer interactions is to functionalize the surface of microsphere with a suitable coupling agent that contains a polymerizable moiety, thus incorporating the material directly into the polymer backbone. Examples of polymerizable moieties are materials that contain olefinic functionality such as styrenic, vinyl (e.g., vinyltriethoxysilane, vinyltri(2-methoxyethoxy) silane), acrylic and methacrylic moieties (e.g., 3-methacrylroxypropyltrimethoxysilane). Examples of useful silanes that may participate in vulcanization crosslinking include 3-mercaptopropyltrimethoxysilane, bis(triethoxysilipropyl)tetrasulfane (e.g., available under the trade designation “SI-69” from Evonik Industries, Wesseling, Germany), and thiocyanatopropyltriethoxysilane. Still other useful silane coupling agents may have amino functional groups (e.g., N-2-(aminoethyl)-3-aminopropyltrimethoxysilane and (3-aminopropyl)trimethoxysilane). Coupling agents useful for peroxide-cured rubber compositions typically include vinyl silanes. Coupling agents useful for sulfur-cured rubber compositions typically include mercapto or polysulfido silanes. Suitable silane coupling strategies are outlined in Silane Coupling Agents: Connecting Across Boundaries, by Barry Arkles, pg 165-189, Gelest Catalog 3000-A Silanes and Silicones: Gelest Inc. Morrisville, Pa.

In some embodiments of the masterbatch and/or rubber composition according to the present disclosure, the glass bubbles may be provided with a polymeric coating as described in Int. Pat. Appl, Pub. Nos. WO2013/148307 (Barrios et al.), WO2014/100593 (Amos et al.), and WO2014/100614 (Amos et al.). The polymeric coating can include a cationic polymer, a nonionic polymer, a conductive polymer, a fluoropolymer (e.g., an amorphous fluoropolymer), an anionic polymer, or a hydrocarbon polymer. In some embodiments, the polymeric coating is a polyolefin (e.g., polyethylene, polypropylene, polybutylene, polystyrene, polyisoprene, paraffin waxes, EPDM copolymer, or polybutadiene) or an acrylic homopolymer or copolymer (e.g., polymethyl acrylate, polyethyl methacrylate, polyethyl acrylate, polyethyl methacrylate, polybutyl acrylate, or butyl methacrylate). In some embodiments, the polymeric coating is selected to be compatible with the rubber composition. Polymeric coatings on glass bubbles may be made, for example, by a process that includes combining a dispersion with a plurality of glass bubbles such that a polymeric coating is disposed on at least a portion of the surfaces of the glass bubbles. The dispersion can include a continuous aqueous phase and a dispersed phase. The continuous aqueous phase includes water and optionally one or more water-soluble organic solvents (e.g., glyme, ethylene glycol, propylene glycol, methanol, ethanol, N-methylpyrrolidone, and/or propanol). The dispersed phase includes any one or more of the polymers as described above. The polymer dispersion can be stabilized with a cationic emulsifier, for example. Cationically-stabilized polyolefin emulsions are readily available from commercial sources, for example, under the trade designation “MICHEM EMULSION” (e.g., grades 09730, 11226, 09625, 28640, 70350) from Michelman, Inc., Cincinnati, Ohio.

In some embodiments, the masterbatch composition includes a processing oil such as those commonly used for rubber processing (e.g., mixing or milling). Useful processing oils include paraffinic processing oils, aromatic processing oils, and naphthene processing oils such as those available, for example, from Process Oils Inc., Houston, Tex., and Michang Oil Ind. Co., Busan, Korea. In some embodiments, the processing oil is paraffinic. The processing oil may be selected based on viscosity or color stability, for example. The masterbatch composition may contain any useful amount of processing oil. In some embodiments, the masterbatch composition includes at least 2 percent by weight or at least 5 percent by weight processing oil (e.g., paraffinic processing oil), based on the total weight of the masterbatch composition. In some embodiments, the masterbatch composition includes up to 15 percent by weight or up to 20 percent by weight processing oil (e.g., paraffinic processing oil), based on the total weight of the masterbatch composition. For example, the masterbatch composition may include processing oil in a range from 1 to 25, 2 to 20, or 2 to 15 percent by weight, based on the total weight of the masterbatch composition.

In some embodiments, the masterbatch composition includes one or more stabilizers (e.g., antioxidants or hindered amine light stabilizers (HALS)). Examples of useful antioxidants include hindered phenol-based compounds and phosphoric acid ester-based compounds (e.g., those available from BASF, Florham Park, N.J., under the trade designations “IRGANOX” and “IRGAFOS” such as “IRGANOX 1076” and “IRGAFOS 168”, those available from Songwon Ind. Co, Ulsan, Korea, under the trade designations “SONGNOX”, and butylated hydroxytoluene (BHT)). Antioxidants, when used, can be present in an amount from about 0.001 to 1 percent by weight based on the total weight of the masterbatch composition. HALS are typically compounds that can scavenge free-radicals, which can result from photodegradation or other degradation processes. Suitable HALS include decanedioic acid and bis (2,2,6,6-tetramethyl-1-(octyloxy)-4-piperidinyl)ester. Suitable HALS include those available, for example, from BASF under the trade designations “TINUVIN” and “CHIMASSORB”. Such compounds, when used, can be present in an amount from about 0.001 to 1 percent by weight based on the total weight of the masterbatch composition.

In some embodiments, the masterbatch composition includes a vulcanization accelerator. A vulcanization accelerator is believed to break sulfur chains and lower the activation energy required for vulcanization. Examples of useful vulcanization accelerators include sulfeneamide vulcanization accelerators (e.g., those made from mercaptobenzothiazole and a primary amine such as cyclohexylamine or tert-butylamine), thiourea vulcanization accelerators (e.g., ethylene thiourea), thiazole vulcanization accelerators (e.g., mercaptobenzothiazole or 2-benzothiazolyl disulfide), dithiocarbamate vulcanization accelerators (e.g., zinc diethyldithiocarbamate and zinc dibutyldithiocarbamate), xanthogenic acid vulcanization accelerators, and thiuram vulcanization accelerators (e.g., tetramethylthiuram disulfide and tetraethylthiuram disulfide). A combination of different classes of vulcanization accelerators may be useful. Such compounds, when used, can be present in an amount from about 0.01 to 2 percent by weight based on the total weight of the masterbatch composition.

In some embodiments, the masterbatch composition includes a vulcanization assistant. Although there are no specific limitations on the type of the vulcanization assistant, poly(ethylene glycol), stearic acid, zinc oxide, or another metal oxide can be useful. Without wanting to be bound by theory, it is believed that in the process of vulcanization, the combination of stearic acid and zinc oxide or another metal oxide provides a rubber-soluble salt that activates the vulcanization accelerators described above. Also, poly(ethylene glycol), which may have any useful molecular weight (e.g., in a range from 200 grams per mole to 8000 grams per mole), is typically compatible with rubbers and may prevent adsorption of the vulcanization accelerators by other components of the rubber composition (e.g., glass bubbles). Vulcanization assistants, when used, can be present in an amount from about 0.01 to 2 percent by weight based on the total weight of the masterbatch composition. The masterbatch may contain a combination of poly(ethylene glycol), stearic acid and zinc oxide, for example, or only one of these compounds.

Reinforcing filler may be useful in the masterbatch composition disclosed herein or in the rubber composition prepared from the masterbatch composition. Reinforcing filler can be useful, for example, for enhancing the durability and strength of the final rubber composition. Also, in rubber processing, filler can be useful for decreasing the stickiness of the rubber processing to facilitate mixing. Examples of useful reinforcing fillers include silica (including nanosilica), other metal oxides, metal hydroxides, and carbon black. Other useful fillers include glass fiber, wollastonite, talc, calcium carbonate, titanium dioxide (including nano-titanium dioxide), wood flour, other natural fillers and fibers (e.g., walnut shells, hemp, and corn silks), and clay (including nano-clay).

However, in some embodiments, the presence of silica in the masterbatch or in the final rubber composition prepared from the masterbatch can lead to undesirable glass bubble breakage. Advantageously, the masterbatch compositions according to the present disclosure allow the pre-mixing of high concentrations of rubber and glass bubbles together in the absence of high filler loadings which can reduce glass bubble breakage either in the masterbatch, in the final let-down rubber composition, or both. Accordingly, in some embodiments, the masterbatch is free of silica filler or contains up to 5, 4, 3, 2, or 1 percent by weight silica filler, based on the total weight of the masterbatch.

For the masterbatch composition according to the present disclosure to be stable and combinable with a variety of rubbers to provide a final, let-down rubber composition, it is useful for the masterbatch to be free of a vulcanizing agent. In some embodiments, a vulcanizing agent may be present in the masterbatch composition but in an amount insufficient to cause crosslinking of the of syndiotactic 1,2-polybutadiene and cis 1,4-polybutadiene in the masterbatch composition. Examples of vulcanizing agents are described in further detail, below.

Masterbatch compositions may be processed in mixers commonly used for making rubber compositions (e.g., roll mills including two-roll mills or a Banbury mixer). Elevated temperatures (e.g., in a range from 50° C. to 125° C.) may be useful. The masterbatch may then be formed into a sheet, or it can be added to a granulator to make pellets or granules.

The present disclosure provides a method of combining the masterbatch composition as described in any of the above embodiments with other rubber polymers to provide a rubber composition. The process of combining a masterbatch with other compatible materials is commonly referred to as “letting down” the masterbatch. In the present disclosure, the rubber composition that is made from the masterbatch can also be referred to as the let-down composition. In the present method of “letting down” the masterbatch composition, the other rubber polymers with which the masterbatch is combined typically include at least one of polyisoprene or a polybutadiene rubber. The polybutadiene rubber can be syndiotactic 1,2-polybutadiene as described above, cis-1,4-polybudiene as described above, or a combination thereof. The polybutadiene rubber may also include other stereoisomers of 1,2-polybutadiene (e.g., isotactic or atactic isomers) or trans-1,4-polybutadiene. The polyisoprene rubber can be natural rubber or a synthetic polyisoprene in any isomeric form. In some embodiments, the rubber polymers useful for letting down the masterbatch composition are selected from the group consisting of polybutadiene and polyisoprene. In some embodiments, the rubber polymers useful for letting down the masterbatch composition are selected from the group consisting of polybutadiene and natural rubber. Natural rubber is available from a variety of commercial sources (e.g., from PhuocHoa Rubber Co., Binh Duong Province, Vietnam, under the trade designation “SVR-3L”).

Other examples of rubber materials that may be useful for letting down the masterbatch composition, depending on the application, include polyisobutylene, ethylene-propylene copolymers, ethylene-propylene-diene terpolymers, sulfonated ethylene-propylene-diene terpolymers, polychloroprene, poly(2,3-dimethylbutadiene), poly(butadiene-co-pentadiene), chlorosulfonated polyethylenes, polysulfide elastomers, silicone elastomers, poly(butadiene-co-nitrile), hydrogenated nitrile-butadiene copolymers, acrylic elastomers, ethylene-acrylate copolymers, fluorinated elastomers, fluorochlorinated elastomers, fluorobrominated elastomers, and combinations thereof. The rubber for letting down the masterbatch composition may be a thermoplastic elastomer. Examples of useful thermoplastic elastomers include block copolymers made up of blocks of glassy or crystalline blocks of, for example, polystyrene, poly(vinyltoluene), poly(t-butylstyrene), and polyester, and elastomeric blocks of, for example, polybutadiene, polyisoprene, ethylene-propylene copolymers, ethylene-butylene copolymers, polyether ester, polyurethane, and combinations thereof. Some thermoplastic elastomers are commercially available, for example, poly(styrene-butadiene-styrene) block copolymers marketed by Kraton Polymers, Houston, Tex., under the trade designation “KRATON”.

The material for combining with or “letting down” the masterbatch composition may also include any of the processing oils, stabilizers (e.g., antioxidants or HALS), vulcanization accelerators, vulcanization assistants, and reinforcing fillers described above in any combination. In some embodiments, the final, “let-down” rubber composition may be free of silica or substantially free of silica or any other of the reinforcing fillers as described above. The term “substantially free” of silica means that the rubber composition may have up to 5%, 4%, 3%, 2%, or 1% by weight silica, based on the total weight of the rubber composition. In some embodiments, the rubber composition according to the present disclosure includes more than 5%, at least 10%, or at least 15% reinforcing filler (e.g., silica), based on the total weight of the rubber composition.

While letting down the masterbatch composition according to the present disclosure is a convenient way for preparing the rubber composition according to the present disclosure, the rubber composition may be prepared in other ways as well, for example, by directly mixing glass bubbles and other ingredients into the rubber composition.

In some embodiments, the rubber composition disclosed herein, which can be conveniently prepared from the masterbatch disclosed herein, has a ratio of syndiotactic 1,2-polybutadiene to cis-1,4-polybutadiene in a range from 50:50 to 10:90. In some embodiments, the ratio of syndiotactic 1,2-polybutadiene to cis-1,4-polybutadiene is in a range from 40:60 to 10:90 or from 40:60 to 15:85. In some embodiments, the rubber composition disclosed herein has glass bubbles in a range up to 25 percent by weight, 24 percent by weight, 23 percent by weight, 22 percent by weight, 21 percent by weight or 20 percent be weight, based on the total weight of the rubber composition. In some embodiments, the rubber composition disclosed herein has glass bubbles in a range from 5 percent to 20 percent by weight, or 5 percent to 15 percent by weight, based on the total weight of the rubber composition.

Typically, material for combining with a masterbatch to provide a rubber composition and the rubber composition disclosed herein, which may be made from the masterbatch composition, includes a vulcanizing agent. A variety of different vulcanizing agents may be useful. Examples of useful vulcanizing agents include types of sulfur such as powdered sulfur, precipitated sulfur, colloidal sulfur, insoluble sulfur, and highly dispersible sulfur and halogenated sulfurs such as sulfur monochloride and sulfur dichloride. The amount of these sulfurs that may be added may be selected based on the desired concentration in the final, end-use rubber composition. Typically the final, end-use rubber composition will have a range from 0.05 percent by weight to 3 percent by weight sulfur, based on the total weight of the rubber composition. In some embodiments, the vulcanizing agent is an organic peroxide (e.g., cyclohexanone peroxide, t-butylperoxyisopropylcarbonate, t-butylperoxylaurate, t-butylperoxyacetate, di-t-butylperoxyphthalate, di-t-butylperoxymaleate, dicumyl peroxide, 1,3-bis(t-butylperoxyisopropyl) benzene, methylethylketoneperoxide, di-(2,4-di chlorobenzoyl) peroxide, 1,1-di(t-butylperoxy)-3,3,5-trimethylcychlohexane, 2,5-dimethyl-2,5-di(benzoylperoxy) hexane, 2,5-dimethyl-2,5-di(t-butylperoxy) hexane, di-t-butylperoxide, 2,5-dimethyl-2,5-(t-butylperoxy)-3-hexyne, n-butyl-4,4-bis(t-butylperoxy) valerate, a,a′-bis (t-butylperoxy)diisopropylbenzene, and combinations thereof). In these embodiments, the amount of organic peroxide may be in a range from 0.05 percent by weight to 5 percent by weight, based on the total weight of the rubber composition.

Other additives may be incorporated into the masterbatch composition or the rubber composition disclosed herein in any of the embodiments described above. Examples of other additives that may be useful, depending on the intended use of the rubber composition, include preservatives, mixing agents, colorants, dispersants, floating or anti-setting agents, flow or processing agents, wetting agents, UV stabilizers, anti-ozonant, and odor scavengers.

Rubber compositions may be processed in mixers as described above for masterbatch compositions (e.g., roll mills including two-roll mills or a Banbury mixer). Mixing at elevated temperatures (e.g., in a range from 50° C. to 125° C.) may be useful.

Rubber compositions according to and/or made according to the present disclosure may be crosslinked at an elevated temperature (e.g., 150° C. to 160° C.) and optionally elevated pressure (e.g., 100 to 150 kg/cm²). In some embodiments, the rubber composition may be molded into a form of an outer shoe sole before heating the rubber composition. Heating may be carried out for any period of time necessary to crosslink the rubber composition, which may be up to 30, 20, or 10 minutes.

The masterbatch composition, method, and/or rubber composition disclosed herein are useful for making low density products (e.g., having a density in a range from 0.85 to 1.0 grams per cubic centimeter) with good tensile strength and abrasion resistance, which are useful properties for a variety of applications. As shown in the Examples, below, abrasion resistances as measured by the NBS durability test that may be achieved by rubber compositions according to and/or made according to the present disclosure can be higher than 300 percent. In some embodiments, the toughening agents disclosed herein provide abrasion resistance without sacrificing other properties. For example, Korean Pat. No. 101217692, published Jan. 2, 2013, reports a high styrene masterbatch useful for providing abrasion resistance in a rubber formulation including glass bubbles. As shown in Illustrative Example 4, below, a high styrene masterbatch provided an increase in abrasion resistance as measured by DIN abrasion but resulted in a sharp in trouser tear strength and tensile strength. In contrast, as shown in Example 5, when a modified PTFE fine powder was added to the formulation, trouser tear strength and tensile strength were largely maintained while reducing the DIN abrasion.

In addition to outer shoe soles, rubber compositions according to and/or made according to the present disclosure can be useful for making other articles (e.g., o-rings, gaskets, tires or portions of tires, and hoses).

### Some Embodiments of the Disclosure

In a first embodiment, the present disclosure provides a masterbatch composition comprising glass bubbles and a toughening agent in a blend of syndiotactic 1,2-polybutadiene and cis-1,4-polybutadiene.

In a second embodiment, the present disclosure provides the masterbatch composition of the first embodiment, wherein the glass bubbles are present in an amount of at least 25 percent by weight, at least 30 percent by weight, or at least 35 percent by weight, based on the total weight of the masterbatch composition.

In a third embodiment, the present disclosure provides the masterbatch composition of the first or second embodiment, wherein the masterbatch does not contain a vulcanizing agent or contains a vulcanizing agent in an amount insufficient to crosslink the blend of syndiotactic 1,2-polybutadiene and cis-1,4-polybutadiene.

In a fourth embodiment, the present disclosure provides the masterbatch composition of any one of the first to third embodiments, wherein the toughening agent is a fluoroplastic, a silicone rubber, an organic or ceramic fiber, or a combination thereof.

In a fifth embodiment, the present disclosure provides the masterbatch composition of any one of the first to fourth embodiments, wherein the toughening agent is a fluoroplastic particle, a fluoroplastic fiber, or a combination thereof. In some of these embodiments, the fluoroplastic is polytetrafluoroethylene or modified polytetrafluoroethylene.

In a sixth embodiment, the present disclosure provides the masterbatch composition of any one of the first to fifth, wherein the toughening agent is a fibrillating or fibrillated fluoroplastic particle. In some of these embodiments, the fluoroplastic is polytetrafluoroethylene or modified polytetrafluoroethylene.

In a seventh embodiment, the present disclosure provides the masterbatch composition of any one of the first to sixth embodiments, wherein the masterbatch composition is free of silica filler or contains up to 5 percent by weight silica filler, based on the total weight of the masterbatch composition.

In an eighth embodiment, the present disclosure provides the masterbatch composition of any one of the first to seventh embodiments, wherein the ratio of syndiotactic 1,2-polybutadiene to cis-1,4-polybutadiene in the blend is in a range from 30:70 to 80:20.

In a ninth embodiment, the present disclosure provides the masterbatch composition of any one of the first to eighth embodiments, wherein the masterbatch composition is substantially free of natural rubber.

In a tenth embodiment, the present disclosure provides the masterbatch composition of any one of the first to ninth embodiments, wherein the masterbatch composition is substantially free of rubbers other than the syndiotactic 1,2-polybutadiene and cis-1,4-polybutadiene.

In an eleventh embodiment, the present disclosure provides the masterbatch composition of any one of the first to tenth embodiments, wherein the glass bubbles have a glass composition comprising SiO₂ in a range from 70 to 80 percent by weight, alkaline earth metal oxide in a range from 8 to 15 percent by weight, and alkali metal oxide in a range from 3 to 8 percent by weight, each percent by weight based on the total weight of the glass bubbles. In this embodiment, the glass composition may comprises B₂O₃ in a range from 2 to 6 percent by weight, based on the total weight of the glass bubbles.

In a twelfth embodiment, the present disclosure provides the masterbatch composition of any one of the first to eleventh embodiments, further comprising a processing oil.

In a thirteenth embodiment, the present disclosure provides the masterbatch composition of the twelfth embodiment, wherein the processing oil is a paraffinic processing oil.

In a fourteenth embodiment, the present disclosure provides the masterbatch composition of any one of the first to thirteenth embodiments, further comprising at least one of poly(ethylene glycol), an antioxidant, a light stabilizer, a vulcanization assistant, or a vulcanization accelerator. For example, in this embodiment, the masterbatch composition can comprises at least one of a hindered phenol antioxidant or a hindered amine light stabilizer.

In a fifteenth embodiment, the present disclosure provides the masterbatch composition of any one of the first to fourteenth embodiments, wherein the glass bubbles have an average true density in a range from 0.35 grams per cubic centimeter to 0.6 grams per cubic centimeter.

In a sixteenth embodiment, the present disclosure provides the masterbatch composition of any one of the first to fifteenth embodiments, wherein the glass bubbles are treated with a coupling agent or provided with a polymeric coating.

In a seventeenth embodiment, the present disclosure provides the masterbatch composition of any one of the first to sixteenth embodiments, wherein a hydrostatic pressure at which ten percent by volume of the glass bubbles collapses is at least about 20 megapascals.

In an eighteenth embodiment, the present disclosure provides the masterbatch composition of any one of the first to seventeenth embodiments in sheet form.

In a nineteenth embodiment, the present disclosure provides the masterbatch composition of any one of the first to seventeenth embodiments in pellet form or granule form.

In a twentieth embodiment, the present disclosure provides a method comprising combining the masterbatch composition of any one of the first to nineteenth embodiments with at least one other polymer to provide a rubber composition.

In a twenty-first embodiment, the present disclosure provides the method of the twentieth embodiments, whererin the at least one other polymer is at least one of a polyisoprene or a polybutadiene.

In twenty-second embodiment, the present disclosure provides the method of the twenty-first embodiment, wherein the polyisoprene is natural rubber.

In a twenty-third embodiment, the present disclosure provides the method of at least one of the twentieth to twenty-second embodiments, wherein a vulcanizing agent is also combined with the masterbatch composition and the at least one other polymer.

In a twenty-fourth embodiment, the present disclosure provides the method of the twenty-third embodiment, further comprising heating the rubber composition.

In a twenty-fifth embodiment, the present disclosure provides the method of the twenty-fourth embodiment, which is a method of making a shoe outer sole, further comprising molding the rubber composition into a form of a shoe outer sole before heating the rubber composition.

In a twenty-sixth embodiment, the present disclosure provides a rubber composition comprising:
syndiotactic 1,2-polybutadiene;
cis 1,4-polybutadiene,
a toughening agent comprising at least one of a fluoroplastic or an organic or ceramic fiber; and
glass bubbles in an amount up to 25, 24, 23, 22, 21, or 20 percent by weight, based on the total weight of the rubber composition.

In a twenty-seventh embodiment, the present disclosure provides the rubber composition of the twenty-sixth embodiment, wherein the toughening agent is a fluoroplastic particle, a fluoroplastic plastic fiber, or a combination thereof. In some of these embodiments, the fluoroplastic is polytetrafluoroethylene or modified polytetrafluoroethylene.

In a twenty-eighth embodiment, the present disclosure provides the rubber composition of the twenty-sixth or twenty-seventh embodiment, wherein the toughening agent is a fibrillating or fibrillated fluoroplastic particle. In some of these embodiments, the fluoroplastic is polytetrafluoroethylene or modified polytetrafluoroethylene.

In a twenty-ninth embodiment, the present disclosure provides the rubber composition of any one of the twenty-sixth to twenty-eighth embodiments, wherein the toughening agent is present in an amount of at least one percent by weight and up to ten percent by weight, based on the total weight of the rubber composition.

In a thirtieth embodiment, the present disclosure provides the rubber composition of any one of the twenty-sixth to twenty-ninth embodiments, wherein the ratio of syndiotactic 1,2-polybutadiene to cis-1,4-polybutadiene is in a range from 50:50 to 10:90;

In a thirty-first embodiment, the present disclosure provides the rubber composition of any one of the twenty-sixth to thirtieth embodiments, wherein the glass bubbles are present in a range from 5 to 20 percent by weight, based on the total weight of the rubber composition.

In a thirty-second embodiment, the present disclosure provides the rubber composition of any one of the twenty-sixth to thirty-first embodiments, wherein the rubber composition further comprises silica filler.

In a thirty-third embodiment, the present disclosure provides the rubber composition of any one of the twenty-sixth to thirty-second embodiments, further comprising a vulcanizing agent.

In a thirty-fourth embodiment, the present disclosure provides the rubber composition of any one of the twenty-sixth to thirty-third embodiments, further comprising a processing oil.

In a thirty-fifth embodiment, the present disclosure provides the rubber composition of the thirty-fourth embodiment, wherein the processing oil is a paraffinic processing oil.

In a thirty-sixth embodiment, the present disclosure provides the rubber composition of any one of the twenty-sixth to thirty-fifth embodiments, further comprising at least one of poly(ethylene glycol), an antioxidant, a light stabilizer, a vulcanization assistant, or a vulcanization accelerator. For example, in this embodiment, the rubber composition can include at least one of a hindered phenol antioxidant or a hindered amine light stabilizer.

In a thirty-seventh embodiment, the present disclosure provides the rubber composition of any one of the twenty-sixth to thirty-sixth embodiments, wherein the glass bubbles have an average true density in a range from 0.35 grams per cubic centimeter to 0.6 grams per cubic centimeter.

In a thirty-eighth embodiment, the present disclosure provides the rubber composition of any one of the twenty-sixth to thirty-seventh embodiments, wherein the glass bubbles are treated with a coupling agent or provided with a polymeric coating.

In a thirty-ninth embodiment, the present disclosure provides the rubber composition of any one of the twenty-sixth to thirty-eighth embodiments, wherein a hydrostatic pressure at which ten percent by volume of the glass bubbles collapses is at least about 20 megapascals.

In a fortieth embodiment, the present disclosure provides the rubber composition of any one of the twenty-sixth to thirty-ninth embodiments, further comprising polyisoprene.

In a forty-first embodiment, the present disclosure provides the rubber composition of the fortieth embodiment, wherein the polyisoprene is natural rubber.

In a forty-second embodiment, the present disclosure provides a vulcanized rubber composition made from the rubber composition of any one of the twenty-sixth to forty-first embodiments.

In a forty-third embodiment, the present disclosure provides a shoe sole made from the rubber composition of any one of the twenty-sixth to forty-first embodiments.

In a forty-fourth embodiment, the present disclosure provides a method of making a shoe outer sole, the method comprising molding the rubber composition of any one of the twenty-sixth to forty-first embodiments into a form of an outer shoe sole before heating the rubber composition.

The following specific, but non-limiting, examples will serve to illustrate the invention. In these examples, all amounts are expressed in parts per hundred resin (phr) unless specified otherwise. In these examples, N/M means “not measured”.

### EXAMPLES

### Materials

| TRADE DESIGNATION | DESCRIPTION | SUPPLIER |
|---|---|---|
| “KOSYN KBR-01L” | 1,4 cis polybutadiene (95% content) rubber | Korea Kumho |
| | having a specific gravity of 0.91 g/cm³. | Petrochemical Co., Seoul, |
| | | Korea. |
| “UBEPOL VCR-617” | Syndiotactic 1,2-polybutadiene rubber (17%) | UBE America Inc., New |
| | and cis-1, 4-polybutadiene rubber | York, NY |
| “JSR RB-830” | Syndiotactic 1,2-polybutadiene rubber (93%) | Japan Synthetic Rubber |
| | | Co., Tokyo, Japan |
| “SVR-3L” | Natural rubber | Phuoc Hoa Rubber Co., |
| | | Binh Duong Province, |
| | | Vietnam |
| none | Butylatedhydroxytoluene (BHT) | Songwon Ind. Co, Ulsan, |
| | (2,6-di-tert-butyl-4-methylphenol) | Korea |
| “KBM-603” | N-2-(aminoethyl)-3- | Shin Etsu Chemical Co., |
| | aminopropyltrimethoxysilane coupling agent | Tokyo, Japan |
| “KONION PEG-4000” | Polyethylene glycol | KPX Green Chemical Co., |
| | | Seoul, Korea. |
| “SONGNOX-1076” | Hindered phenol antioxidant, octadecyl-3- | Songwon Ind. Co |
| | (3,5-di-tert-butyl-4-hydroxyphenyl)propionate | |
| “STRUKTOL SU-135” | Sulfur | Struktol Company of |
| | | America, Stow, OH. |
| “W-1500” | Processing oil | Michang Oil Ind. Co., |
| | | Busan, Korea. |
| None | Stearic Acid | LG Chem |
| “ORICEL DM” | 2-benzothiazoyl disulfide | OCI, Seoul, Korea |
| None | Tetramethylthiuramonosulfide | OCI |
| None | 2-mercaptobenzothiazole (MBT) | OCI |
| None | Zinc Oxide | PJ Chemtech, Yangsan, |
| | | Kyungnam, Korea |
| “3M GLASS BUBBLES | Glass bubbles with a true density of about | 3M Company, St. Paul, |
| K42HS” | 0.42 g/cc and crush strength of 7,500 psi | MN |
| “3M GLASS BUBBLES | Glass bubbles with a true density of about | 3M Company |
| iM16K” | 0.46 g/cc and crush strength of 16,000 psi | |
| “ZEOSIL 175” | Precipitated Amorphous Silica | Rhodia |
| “SI-69” | Bis[3-(triethoxysilyl)propyl]tetrasulfide | Evonik Industries, |
| | | Wesseling, Germany |
| “CF-201U” | Silicone Rubber | Dow Corning, Midland, |
| | | Mich. |
| “KNB 40H” | Acrylonitrile Butadiene Rubber (NBR) | Kumho Petrochemical Co. |
| “KHS 68” | Styrene Butadiene Resin in High Styrene | Kumho Petrochemical Co. |
| | Resin Masterbatch | |
| “DYNEON TFM 2001 Z | Modified PTFE Fine Powder | 3M Company |
| PTFE” | | |
| “DYNEON TFM 2070Z | Modified PTFE Fine Powder | 3M Company |
| PTFE” | | |

### Test Methods

Specific Gravity: specific gravity of the rubber composition examples, below, was measured using a densimeter model MD-200S obtained from A&D Co., Ltd., Tokyo, Japan. The procedure of ASTM D297 was generally followed. Five square specimens measuring 1.3 mm×1.3 mm×0.5 mm were prepared in a press and heated at 150° for five minutes. The weight of the specimen was measured before placing it in water, and the weight and volume of the specimen were measured after soaking it in water. The highest and lowest values were omitted, and the average of the middle three samples was recorded.

Shore A Hardness: Shore A hardness of the rubber composition examples, below, was measured using a ASKER Type A durometer obtained from Kobunshi Keiki Co., Ltd, Kyoto, Japan, according to the procedure generally outlined in ASTM D2240-05, “Standard Test Method for Rubber Property—Durometer Hardness”.

Tensile Strength: tensile strength of the rubber composition examples, below, was measured using an “INSTRON 5567 EH” instrument obtained from Instron, Norwood, Mass., according to the procedure generally outlined in Test Method A of ASTM D412-06ae2, “Tensile Strength Properties of Rubber and Elastomers”.

Tear Strength: tear strength of the rubber composition examples, below, was measured using the “INSTRON 5567 EH” instrument according to the procedure generally outlined in ASTM D624-00, “Standard Test Method for Tear Strength of Conventional Vulcanized Rubber and Thermoplastic Elastomers”.

NBS Abrasion: NBS abrasion of the rubber composition examples, below, was measured using an NBS abrasion tester model 6387 obtained from Yasuda Seiki Seisakusho, Ltd., Hyogo, Japan, according to the procedure generally outlined in ASTM D1630-06, “Standard Test Method for Rubber Property-Abrasion Resistance (Footwear Abrader)”.

DIN Abrasion: DIN abrasion of the rubber composition examples, below, was measured using an Abrasion Machine obtained from Zwick GmbH & Co., Ulm, Germany, according to the procedure generally outlined in DIN 53516, “Testing of Rubber and Elastomers; Determination of Abrasion Resistance.”

Trouser Tear Strength: Trouser Tear Strength of the rubber composition examples, below, was measured measured using an “INSTRON 5567 EH” instrument obtained from Instron, Norwood, Mass., according to the procedure generally outlined in DIN 53507, “Testing Rubber and Elastomers; Determination of the Tear Strength of Elastomers; Trouser Test Piece.

### Masterbatch Composition A

Masterbatch Compositions (MB) A and B were prepared by combining the ingredients listed in Table 1, below, in an 8-liter model DS1-5MHB-E kneader obtained from Moriyama Co., Ltd., Japan. The rubber resins, half of the processing oil, half of the glass bubbles, and the other ingredients were mixed in the kneader at 60° C. for five minutes. The second half of the processing oil and the second half of the glass bubbles were added to the kneader, and mixing was continued for five additional minutes. The compounded resin was then dumped from kneader at a temperature of 120° C. The compounded resin was then mixed in a ten-inch open roll model DJ10-25 obtained from Daejung Precision Co., Korea, at 60° C. for three minutes and formed into a sheet having a thickness of seven to eight millimeters (mm). The sheets were then formed into granules using a model FEX-40 granulator obtained from Fine Machine Industry Co., Ltd. In the granulator, the temperature of the cylinder was 75° C., the temperature of the adaptor was 75° C., and the temperature of the die was 80° C. Care was taken to minimize bubble breakage in each step. In Table 1, composition is expressed in parts per hundred resin (phr) unless noted otherwise.

TABLE 1

| INGREDIENTS | MB A | MB B |
|---|---|---|
| Syndiotactic 1,2-polybutadiene rubber “RB-830” | 40 | 40 |
| 1,4 cis polybutadiene rubber “KOSYN KBR-01L” | 60 | 60 |
| Processing oil “W-1500” | 20 | 20 |
| “3M GLASS BUBBLES K42HS” | 80 | 0 |
| “3M GLASS BUBBLES iM16K” | 0 | 80 |
| “KONION PEG-4000” | 2 | 2 |
| Stearic acid | 1 | 1 |
| Antioxidant “SONGNOX-1076” | 0.3 | 0.3 |
| BHT | 0.5 | 0.5 |
| TOTAL (g) | 203.8 | 203.8 |

The theoretical specific gravity of MB A was 0.62 g/cm³, and the theoretical specific gravity of MB A was 0.66 g/cm³. The specific gravity of MB A was measured as described above, and was found to be 0.65 g/cm³. The specific gravity of MB B was measured as described above, and was found to be 0.58 to 0.61 g/cm³.

### Rubber Composition Controls 1 and 2 and Examples 1 to 6

Rubber Composition Controls Ctr and Ctr 2 and Rubber Composition Examples (Ex) 1 to 6 were prepared by adding Masterbatch Composition A or B to the ingredients listed in Table 2, below. Masterbatch Composition A was combined with all the ingredients listed below except for the sulfur, the tetramethylthiuramonosulfide, the 2-mercaptobenzothiazole, and the 2-benzothiazoyl disulfide in the 8-liter model DS1-5MHB-E kneader (Moriyama Co.) and mixed for eight minutes at 80° C. The final temperature of the rubber composition in the kneader was 90° C. to 100° C. The compounded resin was then dumped from kneader. The compounded resin was then mixed in the ten-inch open roll model DJ10-25 (Daejung Precision Co.) at 60° C. for three minutes and formed into a sheet having a thickness of five to six mm. The sheets were cooled and aged for four hours at room temperature. A portion of a sheet was then combined with the sulfur, tetramethylthiuramonosulfide, 2-mercaptobenzothiazole, and 2-benzothiazoyl disulfide in the open roll. The resulting composition was mixed at 60° C. for four minutes and then formed again into a sheet. Press molding of samples was carried out after aging at room temperature for at least eight hours. In Table 2, composition is expressed in parts per hundred of the rubbers for letting down the masterbatch unless noted otherwise.

TABLE 2

| INGREDIENTS | Ctr 1 | Ex 1 | Ex 2 | Ex 3 | Ex 4 | Ctr 2 | Ex 5 | Ex 6 |
|---|---|---|---|---|---|---|---|---|
| Masterbatch type (MB A or B) | A | A | A | A | A | B | B | B |
| Masterbatch | 25 | 25 | 25 | 25 | 25 | 25 | 30 | 30 |
| Natural rubber “SVR-3L” | 20 | 20 | 20 | 20 | 20 | 45 | 45 | 45 |
| 1,4 cis polybutadiene rubber | 35 | 35 | 35 | 35 | 35 | 10 | 10 | 10 |
| “KOSYN KBR-01L” | | | | | | | | |
| Syndiotactic 1,2-polybutadiene | 45 | 45 | 45 | 45 | 45 | 45 | 45 | 45 |
| rubber and cis-1,4-polybutadiene | | | | | | | | |
| rubber “UBEPOL VCR-617” | | | | | | | | |
| “ZEOSIL 175” | 25 | 25 | 25 | 25 | 25 | 25 | 25 | 25 |
| “SI-69” | 2.0 | 2.0 | 2.0 | 2.0 | 2.0 | 2.0 | 2.0 | 2.0 |
| “DYNEON TFM 2001 Z PTFE” | 0 | 3 | 5 | 10 | 0 | 0 | 3 | 3 |
| “DYNEON TFM 2070Z PTFE” | 0 | 0 | 0 | 0 | 3 | 0 | 0 | 0 |
| “CF-201U” Silicone Rubber | 0 | 0 | 0 | 0 | 0 | 0 | 0 | 2 |
| Sulfur (phr) | 1.5 | 1.5 | 1.5 | 1.5 | 1.5 | 1.5 | 1.5 | 1.5 |
| 2-mercaptobenzothiazole | 1.2 | 1.2 | 1.2 | 1.2 | 1.2 | 1.2 | 1.2 | 1.2 |
| 2-benzothiazoyl disulfide (phr) | 0.8 | 0.8 | 0.8 | 0.8 | 0.8 | 0.8 | 0.8 | 0.8 |
| Tetramethylthiuramonosulfide | 0.1 | 0.1 | 0.1 | 0.1 | 0.1 | 0.1 | 0.1 | 0.1 |
| (phr) | | | | | | | | |

Rubber Compositions Controls 1 and 2 and Rubber Composition Examples 1 to 6 were cut into test plaques and tested according to the test methods described above. Results are shown in Table 3, below. In Table 3, N/M means not measured. Multiple numbers in Table 3 separated by “/” indicates multiple samples were tested.

TABLE 3

| | Specific | | Tensile | Trouser | Tear | NBS | DIN |
|---|---|---|---|---|---|---|---|
| | Gravity | Shore A | strength | Tear | Strength | Abrasion | Abrasion |
| | (g/cm³) | hardness | (kgf/cm²) | (%) | (kg/cm) | (%) | (mm³ loss) |
| Ctr. 1 | 0.980 | 66 | 103/98/93 | 6.7/7.5 | 54.4/47.9 | 298/278 | 126.3 |
| Ex. 1 | 0.992 | 68 | 101/98/97 | 8.3/10.0 | 55.7/57.1 | 379/416 | N/M |
| Ex. 2 | 0.999 | 73 | 97/99/94 | 9.8/10.6 | 55.9/56.7 | 379/463 | N/M |
| Ex. 3 | 1.018 | 77 | 67/73/77 | 12.4/12.2 | 63.6/58.2 | 521/463 | N/M |
| Ex. 4 | 0.987 | 70 | 78/62/63 | 7.2/7.7 | 54.9/57.3 | 347/463 | N/M |
| Ctr. 2 | 0.978 | 67 | 122/118/126 | 16.7/17.6/17.7 | 51.2/53.4 | N/M | 146.3/119.8 |
| Ex. 5 | 0.987 | 68 | 102/117/125 | 14.5/15.0/20/5 | 55.2/44.2 | N/M | 97.6 |
| Ex. 6 | 0.992 | 67 | 97/98/113 | 16.4/19.7/20.2 | 36.1/43.3 | N/M | 96.4 |

### Illustrative Rubber Composition Example 1

Illustrative Rubber Composition Example 1 was prepared in the same manner and with the same ingredients as Rubber Composition Example 5 except that 3 parts per hundred of “KHS-68” based on the weight of the let-down rubbers was used instead of 3 parts per hundred “DYNEON TFM 2001 Z PTFE”. Illustrative Rubber Composition Example 1 was cut into test plaques and tested according to the test methods described above. The results are shown in Table 4, below.

### Illustrative Rubber Composition Example 2

Illustrative Rubber Composition Example 2 was prepared in the same manner and with the same ingredients as Rubber Composition Example 5 except that 3 parts per hundred of “KHS-68” based on the weight of the let-down rubbers was used instead of 3 parts per hundred “DYNEON TFM 2001 Z PTFE” and “KNB-40H” was used instead of “SVR-3L” natural rubber. Illustrative Rubber Composition Example 2 was cut into test plaques and tested according to the test methods described above. The results are shown in Table 4, below.

TABLE 4

| | Specific | | Tensile | Trouser | Tear | DIN |
|---|---|---|---|---|---|---|
| | Gravity | Shore A | strength | Tear | Strength | Abrasion |
| | (g/cm³) | hardness | (kgf/cm²) | (%) | (kg/cm) | (mm³ loss) |
| Ctr. 2 | 0.978 | 67 | 122/118/126 | 16.7/17.6/17.7 | 51.2/53.4 | 146.3/119.8 |
| Ill. Ex. 1 | 0.989 | 68 | 81/98/92 | 7.5/7.6/7.8 | 51.7/51.4 | 90.2/108.4 |
| Ill. Ex. 2 | 0.977 | 68 | 114/113/111 | 9.4/8.9/9.1 | 47.4/46.1 | 115.6/102.6 |

This disclosure is not limited to the above-described embodiments but is to be controlled by the limitations set forth in the following claims and any equivalents thereof. This disclosure may be suitably practiced in the absence of any element not specifically disclosed herein.

1. A masterbatch composition comprising glass bubbles and a toughening agent in a blend of syndiotactic 1,2-polybutadiene and cis-1,4-polybutadiene, wherein the glass bubbles are present in an amount of at least 25 percent by weight, based on the total weight of the masterbatch composition.

2. The masterbatch composition of claim 1, wherein the toughening agent is a fluoroplastic, a silicone rubber, an organic or ceramic fiber, or a combination thereof.

3. The masterbatch composition of claim 1, wherein the toughening agent is a fluoroplastic particle, a fluoroplastic fiber, or a combination thereof.

4. The masterbatch composition of claim 1, wherein the toughening agent is a fibrillating or fibrillated fluoroplastic particle.

5. The masterbatch composition of claim 1, wherein the masterbatch composition is free of silica filler or contains up to 5 percent by weight silica filler, based on the total weight of the masterbatch composition.

6. The masterbatch composition of claim 1, wherein at least one of the following conditions is met:
wherein the glass bubbles have an average true density in a range from 0.35 grams per cubic centimeter to 0.6 grams per cubic centimeter;
wherein a hydrostatic pressure at which ten percent by volume of the first plurality of glass bubbles collapses is at least about 20 megapascals;
wherein the glass bubbles are treated with a coupling agent.

7. The masterbatch composition of claim 1 in sheet form, pellet form, or granule form.

8. A method comprising combining the masterbatch composition of claim 1 with at least one other polymer to provide a rubber composition.

9. A rubber composition comprising:
syndiotactic 1,2-polybutadiene;
cis-1,4-polybutadiene;
a toughening agent comprising at least one of a fluoroplastic or an organic or ceramic fiber;
glass bubbles in an amount up to 25 percent by weight, based on the total weight of the rubber composition.

10. The rubber composition of claim 9, wherein the toughening agent is a fluoroplastic particle, a fluoroplastic fiber, or a combination thereof.

11. The rubber composition of claim 9, wherein the toughening agent is a fibrillating or fibrillated fluoroplastic particle.

12. The rubber composition of claim 9, wherein the toughening agent is present in an amount of at least one percent by weight and up to ten percent by weight, based on the total weight of the rubber composition.

13. The rubber composition of claim 9, wherein at least one of the following limitations is met:
a ratio of syndiotactic 1,2-polybutadiene to cis-1,4-polybutadiene is in a range from 50:50 to 10:90;
the rubber composition further includes silica filler; or
the glass bubbles are treated with a coupling agent.

14. A vulcanized rubber composition made from the rubber composition of claim 9.

15. A method of making a shoe outer sole, the method comprising molding the rubber composition of claim 9 into a form of an outer shoe sole before heating the rubber composition.

16. The rubber composition of claim 9, wherein the fluoroplastic is polytetrafluoroethylene or modified polytetrafluoroethylene.

17. The masterbatch composition of claim 3, wherein the fluoroplastic is polytetrafluoroethylene or modified polytetrafluoroethylene.

18. The masterbatch composition of claim 1, wherein the masterbatch does not contain a vulcanizing agent or contains a vulcanizing agent in an amount insufficient to crosslink the blend of syndiotactic 1,2-polybutadiene and cis-1,4-polybutadiene.

19. The masterbatch composition of claim 1, wherein a ratio of syndiotactic 1,2-polybutadiene to cis-1,4-polybutadiene in the blend is in a range from 30:70 to 80:20.

20. The masterbatch composition of claim 1, further comprising a processing oil.
